(19) United States
(12) Patent Application Publication
(10) Pub. No.: US 2002/0155820 A1
(43) Pub. Date: Oct. 24, 2002

(54) Mobile communicator

(76) Inventors: Shih-Min Wang, Taipei (TW); Shun-Ping Wang, Taipei (TW)

Correspondence Address: BIRCH STEWART KOLASCH & BIRCH, PO BOX 747, FALLS CHURCH, VA, 22040-0747, US

(21) Appl. No.: 09/839,125

(22) Filed: Apr. 23, 2001

(51) Int. Cl. H04B 1/38

(52) U.S. Cl. 455/90; 455/566; 455/575

(57) ABSTRACT

The present invention relates to a mobile communicator, which provides the function of receiving and emitting signals. The appearance and structure of the mobile communicator in the present invention are redesigned. Particularly, its keypad is located on the upper portion of the surface of the mobile communicator, and its display is moved to the lower part. When users hold the mobile communicator in its center-of-gravity position, it is easier for their thumb to reach the buttons on the keypad and operate them. Therefore, the present invention is able to adopt a larger display on the surface of the mobile communicator, in order to improve its style and function.

### BACKGROUND OF THE INVENTION

1. Field of Invention

The present invention pertains to a mobile communicator. More specifically, the invention relates to a mobile communicator, for which the keypad is located on the upper part and the display is set on the lower part.

2. Related Art

Recently, cellular phones have become very popular personal communicators. In their early stages, cellular phones were physically quite large. However, they have been developed into much smaller versions, some even smaller than the palm of the hand. As to their function, cellular phones are capable of many things, from their original function of simply receiving and emitting signals, to the more recent development of providing the function of PDA (Personal Digital Assistant). Even more, users are able to browse and retrieve data on the Internet through cellular phones (a function known as WAP). Furthermore, a kind of cellular phone that is capable of transmitting image data is currently being researched within the industry. It allows users to not only talk with another person, but also to see each other, like talking face to face.

With regard to the designs of cellular phones, please refer to models T2688, T2288, V2288, V2188, V2088, P7689, L/LF2000I, etc., by Motorola Inc., models 8850, 8210, 7110, 3210, etc., by Nokia Mobile Phone Ltd., and models R280LX, R310s, R320s, T20s, etc., by Ericsson Inc. Furthermore, please refer to U.S. Pat. No. D436,102, U.S. Pat. No. D436,090, U.S. Pat. No. D434,744, U.S. Pat. No. D434,743, U.S. PAT. No. D433,003 and U.S. Pat. No. D427,983. Of course, the cellular phones disclosed above are usually designed differently by various manufacturers. However, most of them have some common points, such as an oblong shaped main device body and a similar palm size. From top to bottom there is an antenna, a sound-receiving aperture, a display, a keypad with buttons and a sound-sending aperture on the front side of the main device body. Batteries can be installed in the back side of the main device body. The front side of the main device body is always designed so that the display is set on the upper part and the buttons are located on the lower part.

New functions for cellular phones, such as being capable of applying WAP or being capable of displaying images, are continually being developed. The display area should become as large as possible so that users can more comfortably and conveniently read information from the display. However, all current cellular phones are designed so that the display is set on the upper part and the buttons are located on the lower part of the main device body. So, if the display area becomes larger, the keypad space has to be reduced. The kind of cellular phone with a large display but small keypad (for example: the 7110 model produced by Nokia Mobile Phone Ltd.) has a figure of “big head small body”. Its modeling proportion is out of balance and it appears “top-heavy”. For customers, in addition to some necessary functions, a cellular phone's style and appearance are also important factors in their decision whether to buy it or not. Thus, a model with displeasing style is unlikely to gain any customer's favor.

Moreover, users usually hold a cellular phone in a position around its center of gravity. So, with the design of display up and keypad down, the user's thumb is on the display while the cellular phone is held in the center of the user's palm. In this situation, the user has to use his/her other hand to dial a number. That is to say, it is necessary to operate these kinds of cellular phones by using both of one's hands. Or if the other hand is busy, another method is to move the palm down so that the thumb is able to reach the buttons on lower side, and it becomes a single-handed operation. Nevertheless, with this method of operation, the lower side of the cellular phone may only be grasped by the forefinger and middle finger, with the cellular phone's center of gravity facing outside. It is then very possible that the cellular phone will be dropped if the user is not careful.

### SUMMARY OF THE INVENTION

In view of the foregoing, it is an object of this invention to provide a kind of mobile communicator, in particular, one made by changing the old design of cellular phones. The present invention redesigns the appearance of the cellular phone so that the buttons are located on the upper side of the mobile communicator and the display is moved to the lower side. Then, the style and proportion of the cellular phone's appearance will be more balanced if the display area becomes larger.

Another object of this invention is to create a kind of mobile communicator that is conveniently operated with just one hand. When a user holds the mobile communicator in its center-of-gravity position, his/her thumb will be able to reach the buttons and operate them without using the second hand.

Pursuant to the above objects, the mobile communicator disclosed in the present invention is basically a device body with an oblong shape and a similar palm size. From top to bottom there is an antenna, a sound-receiving aperture, a keypad with buttons, a display and a sound-sending aperture on the front side of the device body. The keypad with buttons is located on the upper side of the device body and the display is located on the lower side of the device body. This will allow the mobile communicator a more balanced style and proportion, and the user's thumb will be able to reach the buttons while the device body is held in the center-of-gravity position, so as to realize the object of operation with just one hand.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein. The description provided below is for illustration only, and thus is not limitative of the present invention, wherein:

FIG. 1 shows a structure schematic view of the present invention.

FIG. 2 shows a schematic view of the present invention while it is used.

### DETAILED DESCRIPTION OF THE INVENTION

The mobile communicator disclosed by the present invention utilizes wireless transmitting technology to receive and emit voice or image signals, like an image cellular phone, in order to reach the object of remote communication. Those technologies concerning cellular phone manufacturing or wireless transmitting are quite mature and are well known by one skilled in the art. Thus, the present description of the invention will not include details about such technologies.

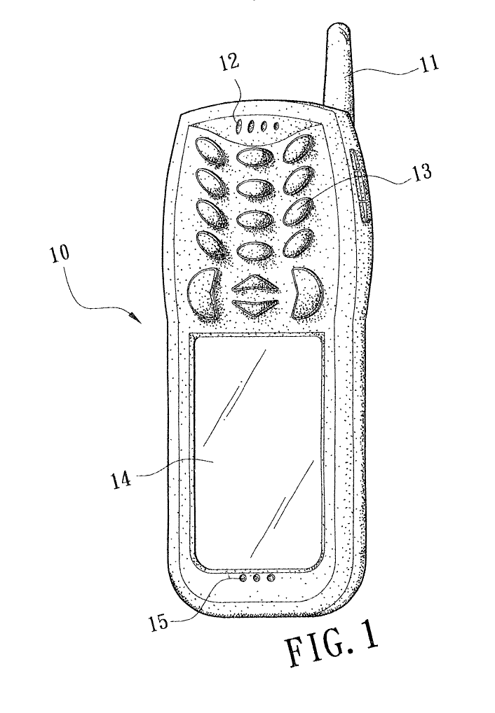

With reference to FIG. 1, the mobile communicator 10 disclosed by the present invention is basically an obling shaped device body with a similar palm size. The front of the mobile communicator 10 includes: an antenna 11, a plurality of sound-sending apertures 12, a keypad with buttons 13, a display 14 and a sound-receiving aperture 15, in that order. The antenna 11 is located on top of the mobile communicator 10 to receive and emit signals. The plurality of sound-sending apertures 12 are located below the antenna 11, and is where the user listens. The keypad with buttons 13 is located below the plurality of sound-sending apertures 12, where there are number buttons, function keys, direction buttons and so on, for inputting information. The display 14 is located below the keypad with buttons 13, and it is able to display information for the user. Finally, the sound-receiving aperture 15 is located below the display 14, and is capable of sending out voice signals.

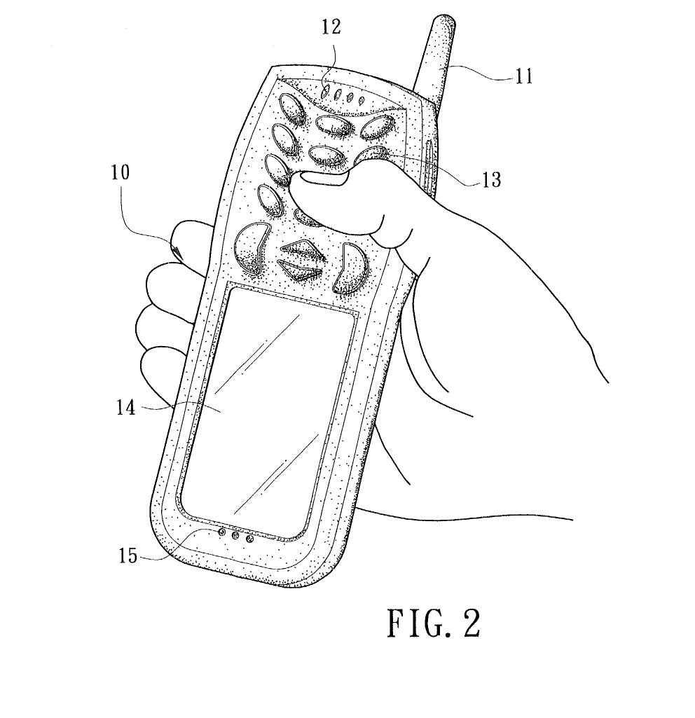

In the present invention, because the display 14 is located below the keypad with buttons 13, the style and shape of the mobile communicator 10 are more balanced if a larger display is adopted for the WAP function or for displaying images. It will not create the appearance of “big head small body” or a “top-heavy” proportion. With reference to FIG. 2, when the mobile communicator 10 is held in the user's palm, the plural buttons 13 can be more easily reached with the thumb, so that the user is able to operate the mobile communicator with only one hand.

Effects of the Invention

With the mobile communicator disclosed according to the present invention, the display is located below the keypad with buttons. Even if a larger display is adopted within the design of the cellular phone, a more balanced and harmonized style can also be achieved. Also, it is able to achieve the object of operation by just a single hand, because the user's thumb can easily reach the buttons when the mobile communicator is held in its center-of-gravity position in the user's palm.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A mobile communicator, which utilizes wireless transmitting technology to receive or emit signals, the appearance of the mobile communicator at least includes a plurality of buttons that is used to input data and a display that is used to show information, the mobile communicator characterized in:
the display is located below the plurality of buttons.

2. The mobile communicator according to claim 1, wherein the appearance further includes an antenna on the top.

3. The mobile communicator according to claim 1, wherein the appearance further includes a sound-taking aperture which is located between the antenna and the plurality of buttons.

4. The mobile communicator according to claim 1, wherein the appearance further includes a sound-sending aperture which is located on the lower position.
